(19) United States
(12) Patent Application Publication
(10) Pub. No.: US 2026/0338667 A1
(43) Pub. Date: Oct. 29, 2026

(54) FLOW CELL AND SAMPLING PROBE

(71) Applicant: Washington University, St. Louis, MO (US)

(72) Inventors: Richard Axelbaum, St. Louis, MO (US); Mao Cheng, St. Louis, MO (US); Zachariah Wargel, St. Louis, MO (US); Duarte Nuno Matos de Barros Magalhaes, St. Louis, MO (US)

(21) Appl. No.: 19/099,685

(22) PCT Filed: Jul. 21, 2023
(86) PCT No.: PCT/US2023/070693

§ 371 Date: Jan. 29, 2025

Related U.S. Application Data
(60) Provisional application No. 63/370,055, filed on Aug. 1, 2022.

(51) Int. Cl. G01N 15/14; G01N 1/22; G01N 15/00; G01N 15/0205; G01N 15/075; G01N 21/03; G01N 21/05; G01N 21/15; G01N 21/53; G01N 21/85

(52) U.S. Cl. CPC G01N 15/1459; G01N 15/0205; G01N 15/075; G01N 21/0317; G01N 21/0332; G01N 21/15; G01N 21/534; G01N 21/85; G01N 2001/2261; G01N 2015/0046; G01N 2015/1493; G01N 2021/052; G01N 2021/158; G01N 2021/536

(57) ABSTRACT

The present disclosure is directed to optical flow cells and sampling probes, and, more specifically, to optical flow cells and sampling probes useful for in-line sampling and optical measurements of particles in industrial fluids and combustion flue gas.

### CROSS-REFERENCE TO RELATED APPLICATIONS

This application claims priority to U.S. Provisional Application Ser. No. 63/370,055, filed on Aug. 1, 2022, the content of which is hereby incorporated by reference in its entirety.

### STATEMENT REGARDING FEDERALLY SPONSORED RESEARCH & DEVELOPMENT

This invention was made with government support under grant number DEFE0031925 awarded by the Department of Energy. The government has certain rights in the invention.

### FIELD OF THE DISCLOSURE

The field of the disclosure relates generally to optical flow cells and sampling probes, and, more specifically, to optical flow cells and sampling probes useful for in-line sampling and optical measurements of particles in industrial fluids and combustion flue gas.

### BACKGROUND OF THE DISCLOSURE

Optical analyzers have been widely applied for the measurement of important properties of molecules, particles, and droplets. For example, Fourier-transform infrared spectroscopy (FTIR) can measure the composition and concentrations of gases that absorb infrared radiation, and scattering analyzers can measure the size distributions and concentrations of particles and/or droplets. These optical analyzers conventionally include an emitter, detector, and flow cell. The flow cell isolates the sampling flow and uses optical windows to allow for an optical beam path between the emitter and detector. A well-designed flow cell should maintain stable flow conditions, avoid any disturbances or sampling bias, and enable continuous, accurate in-situ measurements.

However, in many applications, sampling flows are under harsh conditions. For example, for pressurized oxygen-fuel combustion, the sampling flow is a moist flue gas under high pressure and high temperature, and the fluid contains particles and corrosive acid gases. Most aerosol instruments such as the scanning mobility particle sizer (SMPS), electric low-pressure impactor (ELPI) or optical particle sizer (OPS) are designed to work under atmospheric conditions, making real-time aerosol measurements under pressure and temperature quite challenging. Frequently, measurements of particles and gases from pressurized systems are accomplished by reducing the sampling pressure. However, depressurizing the sample train can cause a biased particle loss during the gas expansion process. In addition, the sampling flow concentration is reduced when reducing the pressure, which decreases the signal-to-noise (SNR) ratio of the instrument. Furthermore, decreasing pressure may change the particle agglomeration dynamics of the aerosol. Therefore, it is desirable to maintain the pressure of the sampling flow when conducting particle measurements.

Moreover, it is important to avoid condensation, and at higher pressure condensation occurs at higher temperature. Therefore, it is important to control the flow cell temperature to avoid condensation. Similar sampling bias issues occur for measuring gas composition. Pressure and temperature requirements have made it a challenge to obtain a flow cell with a high optical quality that does not perturb the particle size distribution or gas composition.

There are a limited number of commercially available flow cells that allow for optical access. For example, Malvern's commercial flow cell for the Insitec analyzer is not designed for conditions of high temperature and pressure. In addition, this flow cell uses a large flowrate of purge gas to shield the windows from the sampling flow and avoid deposition. The large purge flow results in strong mixing with the sampling flow, resulting in a complex flow field in the flow cell. This design can result in (1) a significant dilution of the sampling flow, which may affect the sampling gas and would limit the measurement at low particle concentrations, (2) a risk of particle deposition on the windows, which would then require regular cleaning and (3) a significant uncertainty on measuring particle concentration. Furthermore, to prevent condensation and temperature gradients, heating of the purge flow may be necessary, which would be difficult to do with Malvern's commercial flow cell that is connected to the Insitec analyzer.

There are many commercial gas cells for measuring gas compositions with an FTIR. To protect the optical windows of these gas cells, the gas needs to be free of any particles and/or droplets that could deposit on the windows, and any vapors that could condense in the cell. For example, biomass or coal volatiles contain complex hydrocarbons, which can condense on the optical windows. Removing particles/droplets and/or condensable vapors can be a challenge, especially when sampling a gas of unknown composition, where condensation may occur at an unknown and high temperature.

To address these foregoing challenges, described herein is an optical flow cell. A test system was built for validating this optical flow cell with the Insitec analyzer. A unique sampling probe was designed to sample with minimal particle loss in the sampling line from a 100 kWₜₕ pressurized oxy-coal combustor. The optical flow cell was applied to measure the particle size distribution in-situ for the flue gas under 15 bara. The test results revealed that the measurement zone is well defined for the sampling flow, and the optical windows are well protected by the purge flow, minimizing the risk of particle deposition or condensation. By using this optical flow cell, the Insitec analyzer can successfully measure particle size distribution in high-pressure and high-temperature gas flows, without generating any measurement bias. The optical flow cell can be also used for a wide range of conditions (e.g., 0-100 bara, 0-600 °C, gases optionally containing water vapor and/or corrosive gas). Thus, this optical flow cell expands the applications of optical analyzers, such as an Insitec analyzer, for measurements in diverse processes.

### BRIEF DESCRIPTION OF THE DISCLOSURE

In one embodiment, the present disclosure is directed to an optical flow cell comprising: a sampling flow channel extending in a length direction and a width direction, wherein the sampling flow channel is configured to contain a sampling flow therethrough; a purge flow channel extending in the length direction and the width direction, wherein the purge flow channel at least partially overlaps the sampling flow channel in the width direction and at least partially overlaps the sampling flow channel in the length direction, and wherein the purge flow channel is configured to contain a purging flow therethrough; and a coaxial flow field zone comprising a measurement zone and at least one optical window, wherein the coaxial flow field zone is configured to receive the purging flow from the purge flow channel and the sampling flow from the sampling flow channel, and wherein the measurement zone is configured to receive the sampling flow and a first optical beam that has passed through the at least one optical window.

In another embodiment, the present disclosure is directed to a method of using an optical flow cell comprising: a sampling flow channel extending in a length direction and a width direction, wherein the sampling flow channel is configured to contain a sampling flow therethrough; a purge flow channel extending in the length direction and the width direction, wherein the purge flow channel at least partially overlaps the sampling flow channel in the width direction and at least partially overlaps the sampling flow channel in the length direction, and wherein the purge flow channel is configured to contain a purging flow therethrough; and a coaxial flow field zone comprising a measurement zone and at least one optical window, wherein the coaxial flow field zone is configured to receive the purging flow from the purge flow channel and the sampling flow from the sampling flow channel, and wherein the measurement zone is configured to receive the sampling flow and a first optical beam that has passed through the at least one optical window. The method comprises: flowing the sampling flow through the sampling flow channel; flowing the purging flow through the purge flow channel; receiving the sampling flow from the sampling flow channel and the purging flow from the purge flow channel in a coaxial flow field zone; receiving in the measurement zone the sampling flow and the first optical beam; and optically measuring at least one property of the sampling flow.

In another embodiment, the present disclosure is directed to a sampling probe comprising: a sampling tube extending in a length direction and a width direction, wherein the sampling tube is configured to contain a sampling flow therethrough; a cooling section extending in the length direction and the width direction, wherein the cooling section at least partially overlaps the sampling tube in the width direction and at least partially overlaps the sampling tube in the length direction such that the sampling tube and the cooling section are coaxially aligned; and a gas gap between the cooling section and an outer surface of the sampling tube.

In another embodiment, the present disclosure is directed to a method of sampling a reactor fluid with a sampling probe comprising: a sampling tube extending in a length direction and a width direction, wherein the sampling tube is configured to contain a sampling flow therethrough; a cooling section extending in the length direction and the width direction, wherein the cooling section at least partially overlaps the sampling tube in the width direction and at least partially overlaps the sampling tube in the length direction such that the sampling tube and the cooling section are coaxially aligned; and a gas gap between the cooling section and an outer surface of the sampling tube. The method comprises: flowing a sampling flow from the reactor through the sampling tube; and cooling the sampling flow with the cooling section.

### BRIEF DESCRIPTION OF THE DRAWINGS

FIG. 1 depicts an exemplary embodiment of an optical flow cell for use with an optical particle analyzer in accordance with the present disclosure.

FIG. 2 depicts an exemplary embodiment of an optical flow cell for use with an optical particle analyzer in accordance with the present disclosure.

FIG. 3A depicts the basic design of a Malvern Insitec optical particle analyzer.

FIG. 3B depicts the light-scattering distribution for different particle sizes with the same volume based on Mie theory.

FIG. 4 depicts an exemplary embodiment of an optical flow cell in accordance with the present disclosure.

FIG. 5 depicts an exemplary embodiment of a test system for the flow cell interfaced with an optical particle analyzer in accordance with the present disclosure.

FIG. 6A depicts the Malvern Insitec light background scattering and transmission signals before and after particle testing for more than 100 hours.

FIG. 6B depicts the clearly defined particle measurement zone below the outlet of sampling flow channel in the flow cell in accordance with the present disclosure.

FIG. 7A depicts an exemplary embodiment of particle size distributions of sieved solid particles (sieve medium size is 54 μm), measured by a Malvern Insitec without and with flow cell under normal pressure and temperature in accordance with the present disclosure.

FIG. 7B depicts an exemplary embodiment of particle size distributions of droplets from a nebulizer, measured by a Malvern Insitec without and with flow cell under normal pressure and temperature in accordance with the present disclosure.

FIG. 8 depicts the impact of the Schlieren effect in the flow cell on the scattering signal (detector-1 and -2) and the transmission (detector-0) when increasing the pressure of flow cell to 15 bara at the temperature of 200 °C in accordance with the present disclosure.

FIG. 9 depicts the measured particle size distribution in the flow cell under different conditions by the Malvern Insitec in accordance with the present disclosure.

FIG. 10 depicts an exemplary embodiment of a sampling probe for a pressurized oxy-fuel combustor in accordance with the present disclosure.

FIG. 11 depicts an exemplary embodiment of a particle measurement system for a pressurized oxy-fuel combustor in accordance with the present disclosure.

FIG. 12 depicts a particle size distribution of ash under 15 bara from the bottom of a 100 kWth pressurized oxy-coal combustor in accordance with the present disclosure. The bar graph shows the volume frequency vs particle diameter and the curve shows the cumulative volume vs particle diameter.

FIG. 13 is a diagram depicting an exemplary embodiment of an optical flow cell in accordance with the present disclosure.

FIG. 14 is a diagram depicting an exemplary embodiment of a sampling probe in accordance with the present disclosure.

### DETAILED DESCRIPTION OF THE DISCLOSURE

Described herein is an optical flow cell having a steady, smooth coaxial flow in a coaxial flow field zone, particularly in the optical beam zone of the flow cell. The flow field may include or consist of a laminar flow of purge fluid and a laminar flow of sample. The optical flow cell has a measurement zone at the intersection between the sampling flow and optical beam. The measurement zone may be well defined by the sampling flow field, with minimal influence of the purge flow, by using the coaxial flow field in the flow cell. The optical flow cell may have optical windows mounted on the wall of the purge flow channel. The optical windows may be well protected by the purge flow field, without risk of deposition from the sampling flow.

In many embodiments, the optical flow cell includes: a sampling flow channel extending in a length direction and a width direction, wherein the sampling flow channel is configured to contain a sampling flow therethrough; a purge flow channel extending in the length direction and the width direction, wherein the purge flow channel at least partially overlaps the sampling flow channel in the width direction and at least partially overlaps the sampling flow channel in the length direction, and wherein the purge flow channel is configured to contain a purging flow therethrough; and a coaxial flow field zone comprising a measurement zone and at least one optical window, wherein the coaxial flow field zone is configured to receive the purging flow from the purge flow channel and the sampling flow from the sampling flow channel, and wherein the measurement zone is configured to receive the sampling flow and a first optical beam that has passed through the at least one optical window.

In some embodiments, the coaxial flow field zone comprises a laminar flow of sampling flow from the sampling flow channel and/or a laminar flow of the purging flow from the purge flow channel. In some embodiments, the coaxial flow field zone consists of a laminar flow of sampling flow from the sampling flow channel and/or a laminar flow of the purging flow from the purge flow channel.

In many embodiments, the at least one optical window is not in physical contact with the measurement zone. In some embodiments, the at least one optical window is separated from the measurement zone by the purge flow channel.

In some embodiments, the coaxial flow field zone includes at least two optical windows. In many embodiments, the at least two optical windows are not in physical contact with the measurement zone. In some embodiments, the at least two optical windows are separated from the measurement zone by one or more purge flow channels.

In some embodiments, the first optical window is positioned on a first side of the coaxial flow field zone and the second optical window is positioned on a second side of the coaxial flow field zone. In some embodiments, the second optical window is positioned 180° relative to the first optical window.

In many embodiments, the measurement zone is further configured to emit a second optical beam that has passed through the first optical window and/or a second optical window. In these embodiments, the difference between the second optical beam and the first optical beam results from light scattering and/or absorption of the first optical beam by the sampling flow. The second optical beam may be emitted through the first optical window after scattering or backscattering of the first optical beam in the sampling flow. The second optical beam may be emitted through the second optical window after the first optical beam passes through the sampling flow.

In some embodiments, the at least one optical window is positioned on a surface of the purge flow channel. In some embodiments, the first optical window and/or the second optical window is positioned on a surface of the purge flow channel. In some embodiments, the first optical window and the second optical window are each positioned on a surface of the purge flow channel. The surface may be an internal surface and/or an external surface.

In some embodiments, the measurement zone is contained within the purge flow channel.

In some embodiments, the optical flow cell further includes a pressure vessel extending in the length direction and the width direction. The pressure vessel may at least partially overlap the purge flow channel in the width direction and at least partially overlap the purge flow channel in the length direction. In some embodiments, the pressure vessel overlaps the purge flow channel in the width direction and overlaps the purge flow channel in the length direction.

In some embodiments, the at least one optical window is positioned on an external surface of the pressure vessel. In some embodiments, a third optical window and/or a fourth optical window is positioned on an external surface of the pressure vessel. In some embodiments, the third optical window and the fourth optical window are each positioned on an external surface of the pressure vessel. In some embodiments, the first optical window and the third optical window are both positioned on a first side of the optical flow cell and the second optical window and the fourth optical window are both positioned on a second side of the optical flow cell. In some embodiments, the first optical window, second optical window, third optical window, and fourth optical window are positioned 180° relative to each other.

In some embodiments, the optical flow cell is configured to optically measure at least one property of the sampling flow selected from the group consisting of particle size, particle size distribution, particle concentration, gas composition, gas concentrations, and combinations thereof.

In some embodiments, the optical flow cell is configured to operate at a condition selected from the group consisting of ambient pressure, elevated pressure, ambient temperature, elevated temperature, and combinations thereof. In some embodiments, the optical flow cell is configured to operate under ambient conditions. In some embodiments, the optical flow cell is configured to operate at high pressure and temperature.

In some embodiments, the sampling flow is a flow of a sample selected from the group consisting of a fluid with or without particles, a sample released in production of steam, power, battery materials, cement, chemicals, catalysts, ceramics, carbon, metal oxides, and combinations thereof. In some embodiments, the sampling flow comprises a fluid, a gas, a liquid, a particle, a droplet, or a combination thereof.

In some embodiments, the purging flow is a flow of a purge fluid. In some embodiments, the purge fluid is a purge gas or purge liquid. In some embodiments, the purge gas is selected from the group consisting of carbon dioxide (CO₂), nitrogen (N₂), air, argon (Ar), and combinations thereof.

In some embodiments, the optical flow cell is an in-line optical flow cell. In these embodiments, the optical flow cell may sample a sampling flow from a sample source and then return the sampling flow to the sample source. The sampling flow may be returned at the same location from where it was sampled or at a different location from where it was sampled.

In many embodiments, the optical flow cell may be used in a method including: flowing the sampling flow through the sampling flow channel; flowing the purging flow through the purge flow channel; receiving the sampling flow from the sampling flow channel and the purging flow from the purge flow channel in a coaxial flow field zone; receiving in the measurement zone the sampling flow and the first optical beam; and optically measuring at least one property of the sampling flow.

In many embodiments, the sampling probe includes: a sampling tube extending in a length direction and a width direction, wherein the sampling tube is configured to contain a sampling flow therethrough; a cooling section extending in the length direction and the width direction, wherein the cooling section at least partially overlaps the sampling tube in the width direction and at least partially overlaps the sampling tube in the length direction such that the sampling tube and the cooling section are coaxially aligned; and a gas gap between the cooling section and an outer surface of the sampling tube.

In some embodiments, the sampling probe is configured for sampling a fluid and/or particle at an end of a reactor. In some embodiments, the sampling probe is configured for sampling a fluid and/or particle at a bottom of a reactor.

In some embodiments, a portion of the sampling tube is located inside the reactor and is not surrounded by the cooling section.

Generally, the cooling section may provide cooling and be cooled by any suitable cooling means known in the art. Suitable cooling means include both active and passive means of cooling. In some embodiments, the cooling section comprises a surface having a temperature controlled in a range of from about 20 °C to about 600 °C. The temperature may be controlled by a fluid flow including oil, water, or gas.

In some embodiments, the cooling section comprises a cooled probe. In some embodiments, the cooled probe is a fluid-cooled probe, a water-cooled probe, or an oil-cooled probe.

In some embodiments, the sampling probe is fluidically connected to the optical flow cell. In some embodiments, an outlet of the sampling probe is connected to an inlet of the sampling flow channel.

In many embodiments, the sampling probe may be used in a method of sampling a reactor fluid, the method including: flowing a sampling flow from the reactor through the sampling tube and optionally cooling the sampling flow with the cooling section. The cooling section may be particularly useful to cool sampling flows at temperatures exceeding about 600 °C.

In some embodiments, the reactor fluid comprises a fluid, a gas, a liquid, a particle, a droplet, or a combination thereof.

In some embodiments, the method further includes cooling the sampling flow. In some embodiments, the method further includes cooling the sampling flow with a cooling section probe. In some embodiments, the method further includes cooling the sampling flow with a cooled probe.

In some embodiments, the method further includes flowing the sampling flow to a sampling instrument.

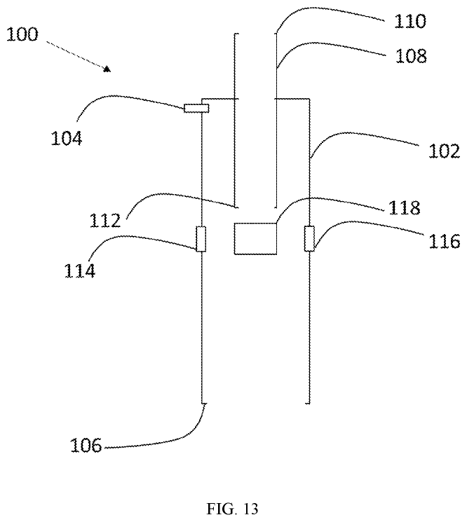

FIG. 13 is an exemplary diagram of an optical flow cell 100. In this exemplary embodiment, optical flow cell 100 depicts an exemplary optical flow cell and is not intended to limit the optical flow cell embodiments. In the exemplary embodiment, optical flow cell 100 includes purging flow channel 102 surrounding sampling flow channel 108. Purging flow channel 102 includes a purging flow inlet 104 and a flow outlet 106. Sampling flow channel 108 includes a sampling flow inlet 110 and a sampling flow outlet 112. A measurement zone 118 is position after the sampling flow outlet 112. The measurement zone 118 is configured to receive a first optical beam (not shown) that has passed through optical window 114. The measurement zone 118 is also configured to emit a second optical beam (not shown) through optical window 116.

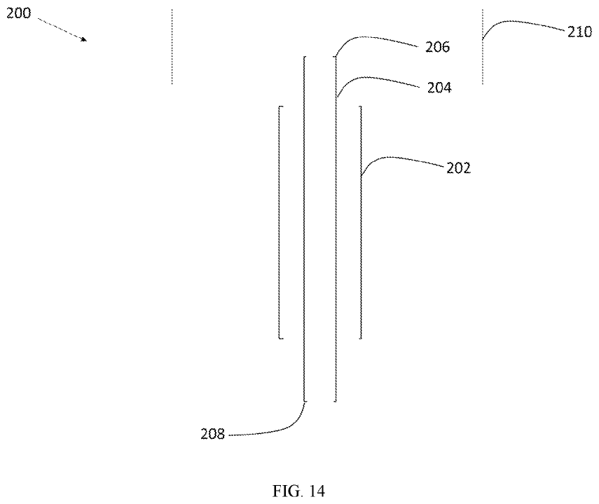

FIG. 14 is an exemplary diagram of a sampling probe 200. In this exemplary embodiment, sampling probe 200 depicts an exemplary sampling probe and is not intended to limit the sampling probe embodiments. In the exemplary embodiment, sampling probe 200 includes sampling tube 204 that is positioned partially within a reactor 210. Sampling tube 204 includes a sampling flow inlet 206 and a sampling flow outlet 208. Sampling tube 204 is surrounded by a cooling section 202. There is a gap between the walls of the cooling section 202 and the walls of sampling tube walls 204. After sampling flow outlet 208, the sampling flow proceeds to an analyzing instrument (not shown).

Further aspects of the present disclosure are provided by the subject matter of the following clauses:
1. An optical flow cell comprising:
a sampling flow channel extending in a length direction and a width direction, wherein the sampling flow channel is configured to contain a sampling flow therethrough;
a purge flow channel extending in the length direction and the width direction, wherein the purge flow channel at least partially overlaps the sampling flow channel in the width direction and at least partially overlaps the sampling flow channel in the length direction, and wherein the purge flow channel is configured to contain a purging flow flowing therethrough; and
a coaxial flow field zone comprising a measurement zone and at least one optical window, wherein the coaxial flow field zone is configured to receive the purging flow from the purge flow channel and the sampling flow from the sampling flow channel, and wherein the measurement zone is configured to receive the sampling flow and a first optical beam that has passed through the at least one optical window.
2. The optical flow cell of the preceding clause, wherein the coaxial flow field zone comprises a laminar flow of the sampling flow from the sampling flow channel and a laminar flow of the purging flow from the purge flow channel.
3. The optical flow cell of any preceding clause, wherein the measurement zone is further configured to emit a second optical beam through the first optical window and/or a second optical window.
4. The optical flow cell of the preceding clause, wherein the difference between the second optical beam and the first optical beam results from light scattering and/or absorption of the first optical beam by the sampling flow.
5. The optical flow cell of any preceding clause, wherein the at least one optical window is positioned on a surface of the purge flow channel.
6. The optical flow cell of any preceding clause, wherein the measurement zone is contained within the purge flow channel.
7. The optical flow cell of any preceding clause, further comprising a pressure vessel extending in the length direction and the width direction, wherein the pressure vessel at least partially overlaps the purge flow channel in the width direction and at least partially overlaps the purge flow channel in the length direction.
8. The optical flow cell of the preceding clause, wherein the pressure vessel comprises at least one optical window positioned on an external surface of the pressure vessel.
9. The optical flow cell of any preceding clause, wherein the optical flow cell is configured to optically measure at least one property of the sampling flow selected from the group consisting of particle size, particle size distribution, particle concentration, gas composition, gas concentrations, and combinations thereof.
10. The optical flow cell of any preceding clause, wherein the optical flow cell is configured to operate at a condition selected from the group consisting of ambient pressure, elevated pressure, ambient temperature, elevated temperature, and combinations thereof.
11. The optical flow cell of any preceding clause, wherein the sampling flow is a flow of a sample selected from the group consisting of a fluid with or without particles, a sample released in production of steam, power, battery materials, cement, chemicals, catalysts, ceramics, carbon, metal oxides, and combinations thereof.
12. The optical flow cell of any preceding clause, wherein the optical flow cell is an in-line optical flow cell.
13. The optical flow cell of any preceding clause, wherein the purging flow is less than or equal to the sampling flow.
14. The optical flow cell of any preceding clause, wherein the purging flow is in a range of from about 0.1 SLPM to about 100 SLPM.
15. The optical flow cell of any preceding clause, wherein the measurement zone is configured to operate with a uniform temperature profile.
16. A method of using an optical flow cell comprising:
a sampling flow channel extending in a length direction and a width direction, wherein the sampling flow channel is configured to contain a sampling flow therethrough;
a purge flow channel extending in the length direction and the width direction, wherein the purge flow channel at least partially overlaps the sampling flow channel in the width direction and at least partially overlaps the sampling flow channel in the length direction, and wherein the purge flow channel is configured to contain a purging flow flowing therethrough; and
a coaxial flow field zone comprising a measurement zone and at least one optical window, wherein the coaxial flow field zone is configured to receive the purging flow from the purge flow channel and the sampling flow from the sampling flow channel, and wherein the measurement zone is configured to receive the sampling flow and a first optical beam that has passed through the at least one optical window,
wherein the method comprises:
   flowing the sampling flow through the sampling flow channel;
flowing the purging flow through the purge flow channel;
   receiving the sampling flow from the sampling flow channel and the purging flow from the purge flow channel in a coaxial flow field zone;
   receiving in the measurement zone the sampling flow and the first optical beam; and
   optically measuring at least one property of the sampling flow.
17. The method of the preceding clause, wherein the property of the sampling flow is selected from the group consisting of particle size, particle size distribution, particle concentration, gas composition, gas concentrations, and combinations thereof.
18. The method of any preceding clause, further comprising emitting a second optical beam through the first optical window and/or a second optical window.
19. The method of the preceding clause, wherein the difference between the second optical beam and the first optical beam results from light scattering and/or absorption of the first optical beam by the sampling flow.
20. The method of any preceding clause, wherein the optical flow cell is configured to operate at a condition selected from the group consisting of ambient pressure, elevated pressure, ambient temperature, elevated temperature, and combinations thereof.
21. The method of any preceding clause, wherein the optical flow cell further comprises a pressure vessel extending in the length direction and the width direction, wherein the pressure vessel at least partially overlaps the purge flow channel in the width direction and at least partially overlaps the purge flow channel in the length direction.
22. The method of the preceding clause, wherein the pressure vessel comprises at least one optical window positioned on an external surface of the pressure vessel.
23. The method of any preceding clause, wherein the optical flow cell is an in-line optical flow cell.
24. The method of any preceding clause, wherein the purging flow is less than or equal to the sampling flow.
25. The method of any preceding clause, wherein the purging flow is in a range of from about 0.1 SLPM to about 100 SLPM.
26. The method of any preceding clause, wherein the measurement zone is configured to operate with a uniform temperature profile.
27. A sampling probe comprising:
a sampling tube extending in a length direction and a width direction, wherein the sampling tube is configured to contain a sampling flow therethrough;
a cooling section extending in the length direction and the width direction, wherein the cooling section at least partially overlaps the sampling tube in the width direction and at least partially overlaps the sampling tube in the length direction such that the sampling tube and the cooling section are coaxially aligned; and
a gas gap between the cooling section and an outer surface of the sampling tube.
28. The sampling probe of the preceding clause, wherein the sampling probe is configured for sampling a fluid and/or particle at a bottom of a reactor.
29. The sampling probe of the preceding clause, wherein a portion of the sampling tube is located inside the reactor and is not surrounded by the cooling section.
30. The sampling probe of any preceding clause, wherein the cooling section is a cooled probe.
31. The sampling probe of any preceding clause, wherein a portion of the sampling tube extends beyond the cooling section and is located inside a reactor.
32. The sampling probe of any preceding clause, wherein the portion of the sampling tube extending beyond the cooling section is at least 20-100% of a thermal entrance length of the sampling tube under the sampling conditions.
33. A method of sampling a reactor fluid with a sampling probe comprising:
a sampling tube extending in a length direction and a width direction, wherein the sampling tube is configured to contain a sampling flow therethrough;
a cooling section extending in the length direction and the width direction, wherein the cooling section at least partially overlaps the sampling tube in the width direction and at least partially overlaps the sampling tube in the length direction such that the sampling tube and the cooling section are coaxially aligned; and
a gas gap between the cooling section and an outer surface of the sampling tube,
wherein the method comprises:
flowing a sampling flow from the reactor through the sampling tube; and
cooling the sampling flow with the cooling section.
34. The method of the preceding clause, wherein a portion of the sampling tube is located inside the reactor and is not surrounded by the cooling section.
35. The method of the preceding clause, further comprising flowing the sampling flow to a sampling instrument.
36. The method of any preceding clause, wherein a portion of the sampling tube extends beyond the cooling section and is located inside a reactor.
37. The method of any preceding clause, wherein the portion of the sampling tube extending beyond the cooling section is at least 20-100% of a thermal entrance length of the sampling tube under the sampling conditions.

### EXAMPLES

Without further elaboration, it is believed that one skilled in the art using the preceding description can utilize the present invention to its fullest extent. The following Examples are, therefore, to be construed as merely illustrative, and not limiting of the disclosure in any way whatsoever. The starting material for the following Examples may not have necessarily been prepared by a particular preparative run whose procedure is described in other Examples. It also is understood that any numerical range recited herein includes all values from the lower value to the upper value. For example, if a range is stated as 10-50, it is intended that values such as 12-30, 20-40, or 30-50, etc., are expressly enumerated in this specification. These are only examples of what is specifically intended, and all possible combinations of numerical values between and including the lowest value and the highest value enumerated are to be considered to be expressly stated in this application.

### Example 1. Flow Cell Design

### Basic Design

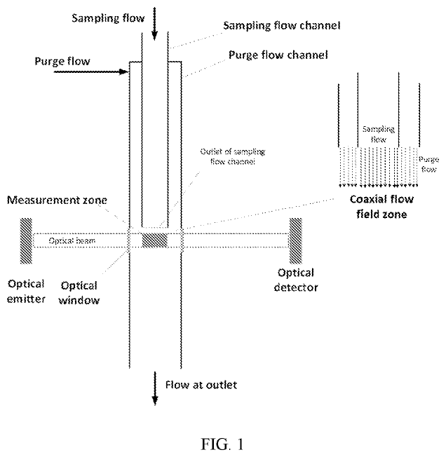

A unique feature of this design, as shown in FIG. 1, is that it creates a steady, smooth coaxial flow field zone in the flow cell, particularly in the optical beam zone of the flow cell, which includes or consists of a laminar flow of purging flow and a laminar flow of sampling flow. The measurement zone is the intersection between the sampling flow and optical beam, as shown in FIG. 1. By using the coaxial laminar flow field in the flow cell, the measurement zone can be well defined by the sampling flow field, without any influence of the purge flow. At the same time, the optical windows, which are mounted on the wall of the purge flow channel, are well protected by the purge flow field, without risk of deposition or condensation from the sampling flow.

To obtain the coaxial laminar flow field in the measurement zone, there is a sampling flow channel to supply laminar flow for the sample, located coaxially with a purge flow channel to supply laminar flow for the surrounding purging flow, as shown in FIG. 1. The outlet of the sampling flow channel is slightly above the measurement zone. The sampling flow channel guides the sampling flow to a point just above the measurement zone, at which point it merges with the purge flow. Due to the laminar nature of both of these flows, minimal mixing occurs. The combined flows leave the system through the outlet flow channel, without disturbing the flow field in the measurement zone.

To avoid any disturbance of the coaxial laminar flow and minimize the mixing of the purge and sampling gases in the measurement zone, (1) the mean gas velocities in the sampling and purge flow channels should be in the range to ensure laminar flow; (2) the temperatures of the sampling and purge fluids should be controlled to avoid condensation; (3) the distance between the outlet of the sampling flow channel and the measurement zone should be small, but should not block any signals from the measurement zone that need to be measured by the detector; and/or (4) the walls of the sampling flow channel and purge flow channel, particularly at the connections of the optical windows and the flow channel, where sampling and purge fluids flow, are designed to be smooth, so as not to induce disturbances to the flow field. By using this unique design, this flow cell can handle moist sampling conditions with corrosive gas, and/or vapors with high dew point. Besides the applications for the particle analyzer, this flow cell can be also applied to an optical gas analyzer such as FTIR.

Application Under High Pressures and Temperatures, with Condensable Corrosive Gases

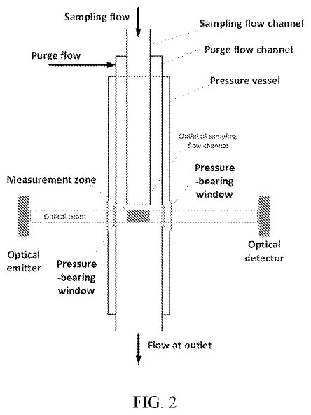

To enable the flow cell to work under high pressure, the purge flow channel and optical windows can be designed to handle high pressures and temperatures. However, it is a challenge to obtain these optical windows and install them. Therefore, in this case, the coaxial vertical flow channels of the sampling and purge are inside of a pressure vessel, which allows measurement of sampling flows to occur under high pressures and temperatures. The outer optical windows are mounted on the wall of the pressure vessel and are rated for the operating pressure and temperature of the pressure vessel. The inner windows, while not pressure sealed, are able to perform at the operating temperature of the flow cell. The inner windows and outer windows should align well with the optical beam zone, as shown in FIG. 2. The clear aperture sizes of the inner windows and outer windows should be large enough to allow all the signals from the measurement zone that need to be measured by the optical detector to pass through the windows. The selected optical windows should minimize the signal loss and noise due to the window itself. Since this design targets on harsh conditions, it can be also applied to moderate conditions relevant to normal pressures at a wide temperature range.

### Example 2. Performative Tests

### Malvern Panalytical Insitec Analyzer

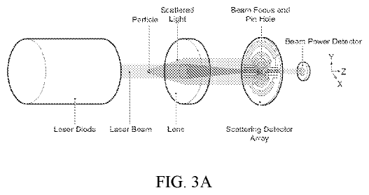

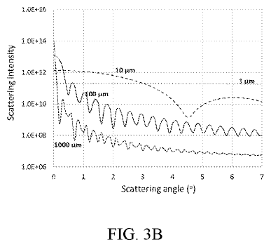

The Insitec analyzer has been widely used for in-situ measurements of particle size distribution (0.1-1000 μm). As particles pass through the laser beam, light scattered in the forward direction is collected by the Fourier lens and focused onto the detector array at the focus plane of lens, as it is shown FIG. 3A. Based on Mie theory, each size of particle has its own characteristic scattering pattern (FIG. 3B). Large particles show a sharper scattering intensity distribution as the scattering intensity reduces significantly at a small angle, while small particles show a flatter distribution as the scattering intensity decreases smoothly at a large angle. To measure the scattering pattern, the analyzer employs a detector array including 32 individual co-annular ring detectors (the two most-inner detectors that are Detector-1 and -2 are not used), each of which measure the light scattered at defined ranges of forward angles. From the smallest angle to the largest angle, the area of a ring detector increases exponentially by about 3 orders of magnitude to capture the weak signal at larger angles. By using the raw scattering data, the particle size distribution (volume based) can be derived based on Mie theory. Light not scattered is focused so that it passes through a 200-micron diameter pinhole in the center of the detector array, and it is measured by the beam power detector (Detector-0) to give a light transmission reading. The RTSizer software, which serves as the interface for the Insitec analyzer, allows inputting of the particle refractive index to make the measurements for the small particles (<5 μm) more accurate.

The particle measurement zone is defined by the dimensions of the particle flow access region. Particles may pass anywhere along the length of the exposed laser beam. Due to the Fourier lens, the collected scattered beams at the same angle can be focused on the same detector, regardless of the positions of the particles. However, it is necessary to observe certain limits on the maximum distance between the light-scattering particle and the Fourier lens. This maximum distance is a function of the lens focal distance and diameter. Exceeding this distance results in vignetting of the signal on the outer detector rings, thereby skewing the calculated size distribution towards the larger particles. For the testing by using Insitec, this will be an extreme testing for flow cell since Insitec is a very sensitive instrument with the array detector and beam power detector. Any minor beam steering, distortion and scattering noise will be monitored by Insitec.

### Flow Cell Mechanical Design

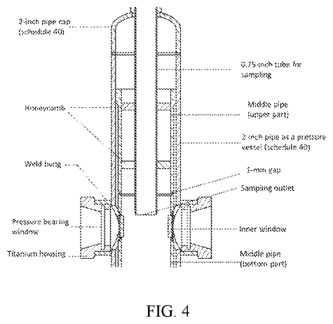

The pressure vessel of the flow cell is a 2-inch Schedule 40 stainless steel (316) pipe. To mount the pressure bearing windows, two weld bungs are welded to the pipe with a mirror symmetry, as shown in FIG. 4. A stainless-steel pipe (316) that is inside of the pressure vessel, referred to as the “middle pipe”, is used for the purge flow channel and the outlet flow channel. The middle pipe is made of two separate parts, the upper and bottom parts, with a 1-mm gap between them. The upper part is welded to the top end of pressure vessel pipe. There are two thin window holders welded on the bottom part of middle pipe to mount the inner windows, which should align with the pressure windows, as shown in FIG. 4. The bottom part of the middle pipe is welded to a flange, so that we can simply take out the bottom part by removing the flange for replacing or cleaning inner windows if necessary. The gap between the upper and bottom parts can also balance the pressures inside of the pressure vessel. A 0.75-inch stainless steel (316) tube is installed in the center of middle pipe to serve as the sampling flow channel, and the sampling outlet should be slightly higher (about 4 mm) than the position of laser beam. For a uniform purge flow, there are two inserts of stainless steel (316) honeycomb between the sampling tube and the middle pipe.

All windows are optical grade and have anti-reflection coatings on both surfaces. This can greatly enhance signal-to-background ratio and improve measurement accuracy and sensitivity. In our case, for the outer optical windows, which must withstand high pressure and an elevated temperature, two high-quality C-plane sapphire windows are used. For the inner windows, two high-quality N-BK7 windows are used. The inner windows are bare glass windows. The pressure window (Encole LLC) is installed within a titanium housing with SAE threads. Titanium has a lower thermal expansion coefficient, which is more suitable for a high-temperature and high-pressure application.

### Test System

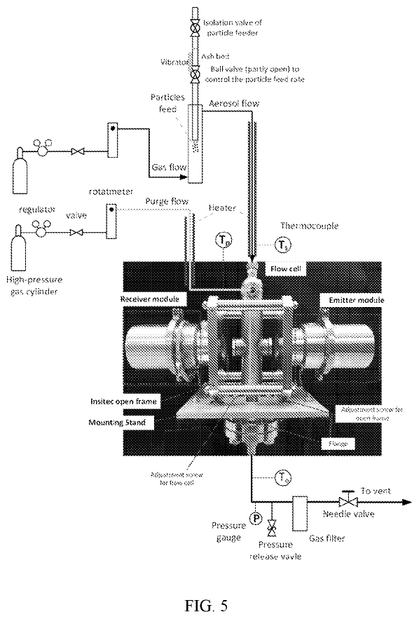

FIG. 5 shows the test system for the flow cell. The Insitec emitter module (left) and receiver module (right) are firmly attached to the Insitec open frame which aligns the two modules. There are also some fine adjustment screws inside the receiver module for the alignment, so that the laser beam can pass through the pinhole in the center of detector array. The Insitec open frame and the flow cell are mounted on a designed metal stand, as shown in FIG. 5. There are several position-adjustment freedoms on the stand for aligning the Insitec and flow cell. A particle feeder system is designed to supply sampling flow for testing the flow cell under the high pressure (15 bara) and high temperatures (200 °C). By using a partially open ball valve with a vibrator, a small number of particles are continuously added to sampling gas line and carried by the gas flow from a high-pressure cylinder. The sampling gas pressure and flowrate are controlled to uniformly transport particles into the flow cell. A similar gas control system is used to supply purge flow to the flow cell. Both the gas flow temperatures are controlled by the heating tapes on the lines connected to the flow cell. Layers of fiberglass insulation and a heater are added to the exterior of the pressure vessel to reduce heat loss. The space between the middle pipe and the pressure vessel, through which no flow travels, acts as an air gap, thereby also serving to reduce heat loss. So, it can be assumed that the temperatures at measurement zone will be near equal to the temperatures of inlet gas flows. The flow cell pressure is controlled by the gas regulators in the system upstream with a needle valve at the downstream.

Table 1 shows the main operating conditions of the test system. The particles that were used were sieved solid particles, with a median sieve size of about 54 μm.

TABLE 1
Operating conditions of the test system for flow cell.

| Condition | Value |
|---|---|
| Sampling fluid flowrate (SLPM) | 3 |
| Purge fluid flowrate (SLPM) | 12 |
| Sampling fluid temperature at the inlet flow cell, Tₛ | 200 |
| (°C) | |
| Purge fluid temperature at the inlet flow cell, Tₚ (°C) | 200 |
| Flow cell operation pressure (bara) | 15 |

### Test Results

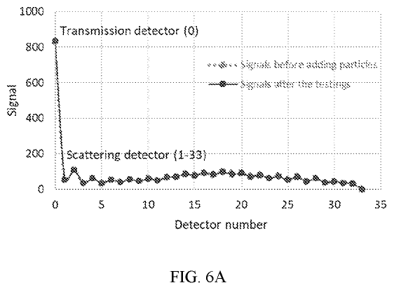

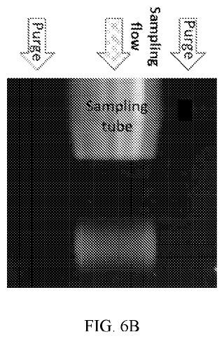

The light background scatterings and transmissions, that are measured by Insitec when there is no particle in the measurement zone, are the same before adding the particles and after the particle testing for about more than 100 hours (FIG. 6A). This verifies that there is no particle deposition on the windows during the particle measurement. Through the coaxial laminar flow field, the measurement zone is clearly defined by the sampling tube in the flow cell (FIG. 6B). The pathlength of measurement zone is equal to the inner diameter of sampling tube, and there is no light scattering at the outside of this measurement zone. Based on this, the pathlength can be simply changed by replacing the sampling tube with one of a different inner diameter, which would enable the Insitec to measure the particles within a large range of concentrations. For a short pathlength, the Insitec can measure particles at a high particle concentration, while for a long pathlength, it can measure particles at a low particle concentration. Further, this clearly defined pathlength of measurement zone is important to accurately measure the particle concentration. The particle concentration (volume based) in sampling from particle feeder is controlled around 93 ppm, and the measured results from Insitec is about 94 ppm. Therefore, there is no dilution of purge fluid in the measurement zone. This flow cell design solves the critical problems of the window fouling and the sampling bias which may result in the measurement failure for this type of optical analyzers.

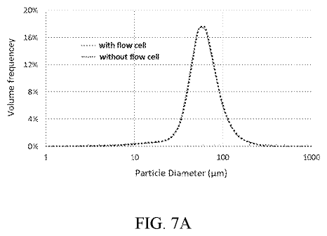

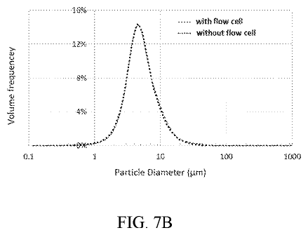

The design of the flow cell is also important to accurately measure the particle size distribution. FIGS. 7A and 7B prove that the flow cell will not induce the measurement bias when measuring the wide range of particle size distributions (1-300 μm of sieved solid particles and 0.1-100 μm of water droplets via a nebulizer). This confirms that the flow cell design is valid. For example, the aperture size of the windows is large enough to pass the scattered lights that needs to be collected, and the beam distortions due to windows are minimized. The Insitec with the flow cell succeeds in measuring the median size of sieved solid particles (54 μm), which agrees with a median size based on the standard sieve.

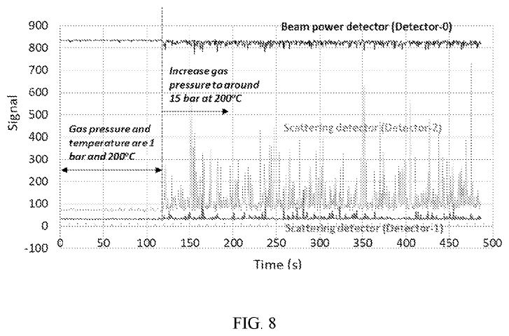

When operating the flow cell under high temperatures (up to 300 °C) at atmospheric pressure or under high pressures (up to 15 bara) at room temperature, there is generally no significant beam steering observed. However, under high-pressure and high-temperature conditions, beam steering can become more apparent in the flow cell. The increased pressure and temperature exacerbate any temperature gradients present in the beam zone, leading to beam steering caused by the Schlieren effect. FIG. 8 illustrates the effects of increasing the flow cell pressure to 15 bara at 200 °C. In this scenario, there are noticeable fluctuations in transmission and scattering signals, particularly in the two innermost detectors (Detector-1 and Detector-2), with Detector-2 exhibiting the largest signal variations. Some of the beam hitting Detector-2 and Detector-1 can be attributed to the Schlieren effect. However, these inner detectors are typically not utilized for measuring particle size distribution with the Insitec analyzer.

To mitigate the impact of the Schlieren effect, several measures are taken. Firstly, the Insitec system employs light background subtraction to remove any noise caused by the Schlieren effect when calculating particle size distribution. Additionally, under high pressure (5-100 bara) and high temperature (100-600 °C), the Schlieren effect may cause failure of the measurement. However, this issue is readily mitigated by employing a small purge flow (0.1-100 SLPM) within the flow cell. This small purge flow is less than or equal to the sampling flow. The small purge flow contributes to establishing a uniform gas temperature profile in the measurement zone of the flow cell in order to avoid beam steering. Finally, a uniform gas temperature profile can be established in the measurement zone of the flow cell via control of the flow cell inner surface temperatures, purging flow temperature at the flow cell inlet, and/or the sampling flow temperature at the flow cell inlet. By establishing a uniform temperature profile in the measurement zone of the flow cell, the influence of the Schlieren effect on particle measurements under high-pressure and high-temperature conditions can be minimized.

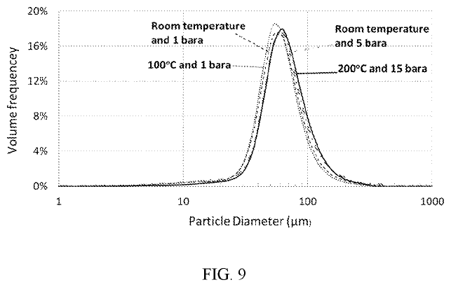

As FIG. 9 shows, with the flow cell described herein, Insitec can succeed to measure the particle size distribution under 200 °C and 15 bara. The measured particle size distribution under 200 °C and 15 bara is slightly right-shifted. This is likely due to some particle agglomeration under high pressure.

### Example 3. In-Situ Measurements in a Pressurized Oxy-Fuel Combustor Under Pressure

### Sampling Probe and Insitec Measurement System

An isokinetic sampling probe plays a crucial role in measuring particle size distribution in a gas and particle mixture sampled from a combustor/reactor to the probe. The design of the sampling line should aim to minimize particle loss by avoiding the forces that can cause particle depositions on the inner walls of the tube. These forces may arise from particle impact, thermophoretic force, gravity, and lift force, and should be avoided or minimized. It is worth noting that the thermophoretic force can be dominant factor contributing to particle loss in the size range of 0.1-10 μm. Described herein is a design for a sampling probe that addresses the issue of thermophoretic force by carefully controlling the temperature profile along the inner wall of the probe. The primary objective is to prevent significant temperature gradiences perpendicular direction of sampling flow, while still allowing for the necessary cooling of the sampling flow.

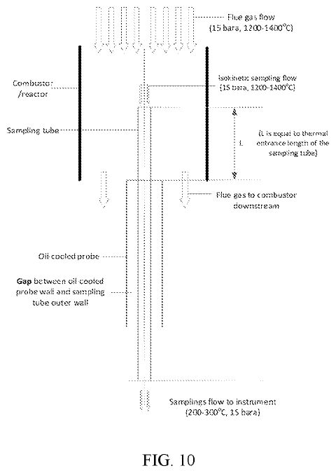

FIG. 10 illustrates the design of the sampling probe intended for sampling at the bottom of a pressurized oxy-fuel combustor. The flue gas flow from this combustor, operating at 100 kWₜₕ under 15 bara, can reach 1300-1400 °C. The sampling probe is designed to enable isokinetic sampling vertically at the bottom of the combustor. It includes an oil-cooled probe and a sampling tube. Previous approaches commonly employed only the oil-cooled probe as the sampling tube without incorporating a center tube. However, this resulted in a sudden cooling of the sampling flue gas at the entrance of the probe, leading to significant temperature gradients.

To overcome this issue, the present design incorporates a sampling tube within the center channel of the oil-cooled probe. Additionally, a certain length of the sampling tube extends beyond the oil-cooled probe tip and is located inside of the combustor. This length is at least 20-100% of the thermal entrance length of the sampling tube under the sampling conditions. By positioning the developing boundary layer of the sampling tube within the high-temperature environment, large temperature gradients caused by the thin boundary layer at the entrance of the sampling tube can be avoided. The oil flow circulating through the probe serves to cool it down and maintains a temperature of around 200-250 °C. This cooling mechanism not only prevents overheating of the oil-cooled probe but also mitigates the condensation of water and acid vapor. Furthermore, the oil flow cools down the center sampling tube. Importantly, there exists a gas gap between the inner wall of the oil-cooled probe and the sampling tube. This arrangement facilitates a gradual cooling process for the sampling gas, starting from 1300-1400 °C at the inlet of the sampling tube and gradually decreasing to 200-300 °C at the inlet of the flow cell.

The sampling probe is installed vertically at the bottom of the combustor/reactor, which ensures that there are no particle gravity settlings. Furthermore, the isokinetic sampling flow within the sampling tube is in a laminar state, making it possible to disregard the influence of lift force. To minimize the effects of particle impact, the entire sampling line is designed to be smooth, avoiding any sudden changes in cross-sectional area or sharp turns. These design considerations contribute to reducing the impact of particle effects on the sampling process.

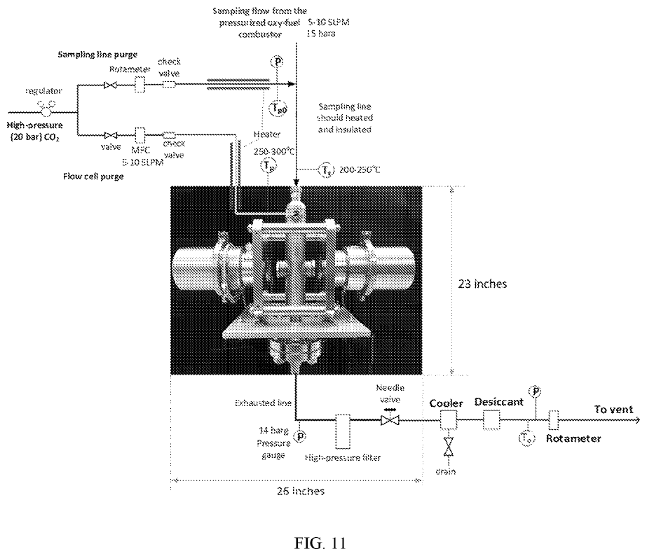

FIG. 11 shows the particle measurement system used for the pressurized oxy-fuel combustor. The mounting and alignment of the flow cell and Insitec are identical to the testing system shown in FIG. 5. However, in this setup, the flow cell purge is regulated by a mass flow controller to ensure a more stable flow, typically ranging from 5-10 SLPM, during the measurement. The isokinetic flowrate of sampling, which originates from the sampling probe, is adjusted using a needle valve downstream of the flow cell. To prevent vapor condensation on the inner windows of the flow cell and the tube walls, the temperatures of the purge line, sampling line, flow cell body, and exhausted line are controlled within the range of 200-300 °C. The flow cell pressure is maintained equal to the sampling pressure (15 bara). By maintaining the stable flows for both purge and sampling, along with stable system temperatures and pressure, it becomes possible to establish a uniform temperature profile within the beam zone inside of the flow cell. This, in turn, enables the acquisition of a stable scattering background with minimal beam steering, which is critical for obtaining accurate measurements of particle size distribution.

A high-pressure high-temperature filter is installed in the exhausted line to capture the particles, ensuring proper functioning of the needle valve. Additionally, a rotameter is incorporated into the exhausted line to monitor the total flowrate from the flow cell. By subtracting the purge flowrate from the total flowrate, the sampling flowrate can be determined. A cooler and desiccant are employed to remove the water vapor so that the rotameter can function properly without interference from condensates.

To prevent blockage at the sampling tube inlet inside the combustor, particularly in the presence of ash slagging resulting from coal combustion, the total sampling time is limited to approximately 10-30 minutes. Furthermore, a reverse sampling line purge flow consisting of CO₂, typically ranging from 10 to 20 SLPM, is directed towards the sampling tube inlet when sampling is not taking place. This purge flow acts as a protective measure for the sampling tip. A split-stream is derived from the sampling line purge flow, which is equal to the sampling flowrate, and it flows into the flow cell. This arrangement helps maintain a coaxial laminar flow field and a uniform temperature profile within the flow cell when sampling is not occurring. This ensures the stability and consistency of the flow cell's performance.

### Measurement Results of Particle Size Distribution

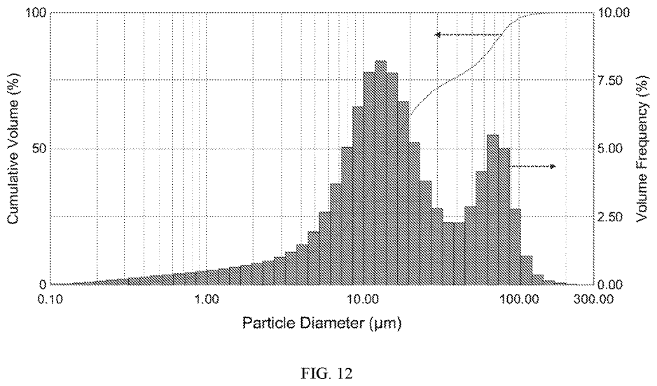

In FIG. 12, the particle size distribution resulting from the sampling of the pressurized oxy-coal combustor at 100 kWh is presented. The distribution exhibits a bimodal pattern, characterized by two prominent volume frequency peaks observed at approximately 14 μm and 74 μm. The small particles, around 14 μm in size, correspond to the fly ash generated from coal combustion. These particles are typically lighter and more easily transported by the flue gas. On the other hand, the large particles, around 74 μm in size, could be attributed to bottom ash or the agglomeration of smaller particles under the conditions of high pressure and high temperature.

After conducting the measurements, all the particles present in the sampling line, flow cell, and exhausted line were collected for analysis. In the designed sampling probe, the loss of fine particles accounted for less than 3% of the total collected particles. To provide a comparison, a measurement was performed using a conventional oil-cooled probe without the center tube. This type of probe exhibited a large temperature gradient at the entrance area of the sampling tube. In this case, the fine particle loss in the oil-cooled sampling probe amounted to over 20% of the total collected particles. These results indicate that the designed sampling probe effectively minimizes the impact of thermophoresis and successfully avoids significant loss of fine particles within the sampling tube. By controlling the temperature profile along the inner wall of the probe, the adverse effects of thermophoresis were able to be mitigated and minimal particle loss during sampling was ensured.

In the particle measurement using Insitec, the beam transmission is found to be around 97-99%, indicating a low particle concentration in the sampling from pressurized oxy-coal combustion. This low particle concentration can be attributed to the majority of ash particles becoming slag and adhering to the walls of the combustor. As a result, the scattering pattern signals are limited to the range of 0-66 in this measurement, whereas the maximum scattering measurement range can reach up to 0-2000. Low scattering signals are common in various industrial processes where the particle concentrations in the flow stream are low. It is crucial to avoid dilution of the sampling to maintain a sufficient signal-to-noise ratio for accurate particle size distribution measurements across a wide range. The conventional Malvern flow cell utilizes a purge flow, which is at least 47.4 SLPM higher than the sampling flow, to protect the flow cell windows, but this can significantly dilute the sampling in many cases when there is no large sampling flow, reduce the signal-to-noise ratio, and make measurements impossible in low-signal scenarios. During in-situ measurements, it was observed that the background scattering patterns tend to be unstable under high pressure and temperature due to increased Schlieren effects. Increasing the flow cell purge flow exacerbates the Schlieren effect, making it challenging to obtain a stable scattering background under such conditions. In contrast, the coaxial laminar flow field provided by the present flow cell design facilitates the establishment of a uniform temperature profile in the measurement zone with less purge flow and a simplified flow structure. Compared to the complex mixing flow field in the Malvern flow cell, the coaxial laminar flow field is less prone to enhancing the Schlieren effect under high pressure and temperature conditions. This allows Insitec with the new flow cell design to be applicable across a wide range of conditions. It can be used for measuring particle size distribution in various applications, including conventional coal power plants, next-generation carbon capture processes, gas-solid catalytic processes, and particle materials production processes under high pressure and temperature.

### CONCLUSIONS

Described herein is an optical flow cell design that can be effectively utilized with advanced optical analyzers. To showcase its capabilities, the flow cell was implemented in conjunction with the Malvern Insitec particle analyzer under challenging sampling conditions involving high pressure, high temperature, and corrosive moist gases. The experimental results demonstrate that the flow cell provides a well-defined measurement zone achieved through the coaxial laminar flow field.

This setup offers several advantages. First, the optical windows of the flow cell are effectively protected by the purge flow, minimizing the risk of deposition from the sampling flows. This ensures the integrity and longevity of the optical components. Second, the sampling flow within the measurement zone remains undiluted by the purge flow, allowing for accurate particle size distribution measurements without significant interference. Third, the flow cell design promotes a stable scattering background even under high pressure and temperature conditions, resulting in minimal beam steering and ensuring reliable measurement results.

The testing outcomes reveal that the Insitec Analyzer, equipped with this flow cell, successfully measures the particle size distribution under high pressure and high temperature without introducing measurement biases. Specifically, the Insitec Analyzer, paired with the flow cell, achieved in-situ measurements of particle size distribution in the sampling flow extracted from a 100 kWₜₕ pressurized oxy-coal combustor. The obtained results exhibit a bimodal distribution of particle sizes, which holds significance for the design and operation of power plant boilers.

Unless otherwise indicated, approximating language, such as “generally,” “substantially,” and “about,” as used herein indicates that the term so modified may apply to only an approximate degree, as would be recognized by one of ordinary skill in the art, rather than to an absolute or perfect degree. Accordingly, a value modified by a term or terms such as “about,” “approximately,” and “substantially” is not to be limited to the precise value specified. In at least some instances, the approximating language may correspond to the precision of an instrument for measuring the value. Additionally, unless otherwise indicated, the terms “first,” “second,” etc. are used herein merely as labels, and are not intended to impose ordinal, positional, or hierarchical requirements on the items to which these terms refer. Moreover, reference to, for example, a “second” item does not require or preclude the existence of, for example, a “first” or lower-numbered item or a “third” or higher-numbered item.

Although specific features of various embodiments of the invention may be shown in some drawings and not in others, this is for convenience only. Moreover, references to “some embodiments” in the above description are not intended to be interpreted as excluding the existence of additional embodiments that also incorporate the recited features. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

As used herein, the terms “comprises,” “comprising,” “includes,” “including,” “has,” “having,” “contains”, “containing,” “characterized by” or any other variation thereof, are intended to cover a non-exclusive inclusion, subject to any limitation explicitly indicated. For example, a composition, mixture, process or method that comprises a list of elements is not necessarily limited to only those elements but may include other elements not expressly listed or inherent to such composition, mixture, process or method.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition or method that includes materials, steps, features, components, or elements, in addition to those literally disclosed, provided that these additional materials, steps, features, components, or elements do not materially affect the basic and novel characteristic(s) of the claimed disclosure. The term “consisting essentially of” occupies a middle ground between “comprising” and “consisting of”.

Where a disclosure or a portion thereof is defined with an open-ended term such as “comprising,” it should be readily understood that (unless otherwise stated) the description should be interpreted to also describe such a disclosure using the terms “consisting essentially of” or “consisting of.”

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the disclosure are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

What is claimed is:

1. An optical flow cell comprising:
a sampling flow channel extending in a length direction and a width direction, wherein the sampling flow channel is configured to contain a sampling flow therethrough;
a purge flow channel extending in the length direction and the width direction, wherein the purge flow channel at least partially overlaps the sampling flow channel in the width direction and at least partially overlaps the sampling flow channel in the length direction, and wherein the purge flow channel is configured to contain a purging flow flowing therethrough; and
a coaxial flow field zone comprising a measurement zone and at least one optical window, wherein the coaxial flow field zone is configured to receive the purging flow from the purge flow channel and the sampling flow from the sampling flow channel, and wherein the measurement zone is configured to receive the sampling flow and a first optical beam that has passed through the at least one optical window.

2. The optical flow cell of claim 1, wherein the coaxial flow field zone comprises a laminar flow of the sampling flow from the sampling flow channel and a laminar flow of the purging flow from the purge flow channel.

3. The optical flow cell of claim 1, wherein the measurement zone is further configured to emit a second optical beam through the first optical window and/or a second optical window.

4. The optical flow cell of claim 1, wherein the purging flow is less than or equal to the sampling flow.

5. The optical flow cell of claim 1, wherein the at least one optical window is positioned on a surface of the purge flow channel.

6. The optical flow cell of claim 1, wherein the measurement zone is contained within the purge flow channel.

7. The optical flow cell of claim 1, further comprising a pressure vessel extending in the length direction and the width direction, wherein the pressure vessel at least partially overlaps the purge flow channel in the width direction and at least partially overlaps the purge flow channel in the length direction.

8. The optical flow cell of claim 1, wherein the measurement zone is configured to operate with a uniform temperature profile.

9. The optical flow cell of claim 1, wherein the optical flow cell is configured to optically measure a property of the sampling flow selected from the group consisting of particle size, particle size distribution, particle concentration, gas composition, gas concentrations, and combinations thereof.

10. The optical flow cell of claim 1, wherein the optical flow cell is configured to operate at a condition selected from the group consisting of ambient pressure, elevated pressure, ambient temperature, elevated temperature, and combinations thereof.

11. The optical flow cell of claim 1, wherein the sampling flow is a flow of a sample selected from the group consisting of a fluid with or without particles, a sample released in production of steam, power, battery materials, cements, chemicals, catalysts, ceramics, carbon, metal oxides, and combinations thereof.

12. The optical flow cell of claim 1, wherein the optical flow cell is an in-line optical flow cell.

13. A method of using an optical flow cell comprising:
a sampling flow channel extending in a length direction and a width direction, wherein the sampling flow channel is configured to contain a sampling flow therethrough;
a purge flow channel extending in the length direction and the width direction, wherein the purge flow channel at least partially overlaps the sampling flow channel in the width direction and at least partially overlaps the sampling flow channel in the length direction, and wherein the purge flow channel is configured to contain a purging flow flowing therethrough; and
coaxial flow field zone comprising a measurement zone and at least one optical window, wherein the coaxial flow field zone is configured to receive the purging flow from the purge flow channel and the sampling flow from the sampling flow channel, and wherein the measurement zone is configured to receive the sampling flow and a first optical beam that has passed through the at least one optical window,
wherein the method comprises:
flowing the sampling flow through the sampling flow channel;
flowing the purging flow through the purge flow channel;
receiving the sampling flow from the sampling flow channel and the purging flow from the purge flow channel in a coaxial flow field zone;
receiving in the measurement zone the sampling flow and the first optical beam; and
optically measuring at least one property of the sampling flow.

14. A sampling probe comprising:
a sampling tube extending in a length direction and a width direction, wherein the sampling tube is configured to contain a sampling flow therethrough;
a cooling section extending in the length direction and the width direction, wherein the cooling section at least partially overlaps the sampling tube in the width direction and at least partially overlaps the sampling tube in the length direction such that the sampling tube and the cooling section are coaxially aligned; and
a gas gap between the cooling section and an outer surface of the sampling tube.

15. The sampling probe of claim 14, wherein a portion of the sampling tube extends beyond the cooling section and is located inside a reactor.

16. The sampling probe of claim 15, wherein the portion of the sampling tube extending beyond the cooling section is at least 20-100% of a thermal entrance length of the sampling tube under the sampling conditions.

17. The sampling probe of claim 14, wherein the cooling section is a cooled probe.

18. A method of sampling a reactor fluid with a sampling probe comprising:
a sampling tube extending in a length direction and a width direction, wherein the sampling tube is configured to contain a sampling flow therethrough;
a cooling section extending in the length direction and the width direction, wherein the cooling section at least partially overlaps the sampling tube in the width direction and at least partially overlaps the sampling tube in the length direction such that the sampling tube and the cooling section are coaxially aligned; and
a gas gap between the cooling section and an outer surface of the sampling tube,
wherein the method comprises:
flowing a sampling flow from the reactor through the sampling tube; and
cooling the sampling flow with the cooling section.

19. The method of claim 18, wherein a portion of the sampling tube is located inside the reactor and is not surrounded by the cooling section.

20. The method of claim 18, further comprising flowing the sampling flow to a sampling instrument.
